(19) United States
(12) Patent Application Publication
(10) Pub. No.: US 2010/0082436 A1
(43) Pub. Date: Apr. 1, 2010

(54) SEARCH RESULTS FOR LOCAL VERSUS TRAVELER

(75) Inventors: Farzin Maghoul, Hayward, CA (US); Jeonghee Yi, San Jose, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/241,395

(22) Filed: Sep. 30, 2008

(51) Int. Cl. G06F 7/06; G06F 17/30; G06Q 30/00

(52) U.S. Cl. 705/14.58; 707/E17.108; 707/E17.018; 705/14.55

(57) ABSTRACT

A method is disclosed for serving user queries adaptively based on whether the query is submitted by a local user or a traveler, including receiving by a search engine a query from a communication device, the query including one or more search terms; detecting a type of keyword term by a context detector of the search engine that indicates a geographic context of the query; determining whether a user of the communication device is the local user or the traveler based on the geographic context; and delivering geographically-targeted search results by the search engine to the communication device based on determining that the user is either the traveler or the local user.

### BACKGROUND

1. Technical Field

The disclosed embodiments relate to database or online search, and more particularly, to generating geographically-targeted search results from a database based on whether a user submitting the query is a local user or a traveler.

2. Related Art

Consumers and business people increasingly use mobile phones or similar devices with which to communicate and to obtain information, e.g., in conducting research or simply to learn about the weather in an area during the next week. These same people also look up information on the World Wide Web (“Web”) or Internet (via mobile device or personal computer) to find information regarding goods and services in commerce. Trends are detectable in regards to the type of language used in search queries by searchers of the Internet. Major search engines such as those of Yahoo! of Sunnyvale, Calif. and Google of Mountain View, Calif. have volumes of search data within their search logs from which to obtain information required to track and/or predict such trends. Internet searchers often formulate search queries in unintended ways, which lead to undesirable search results. In other cases, some queries by their nature would yield better results if the search engine incorporated a geographic context in generating search results, thus narrowing the search results to what is more geographically-relevant to the searchers. This is especially true for certain types of queries related to commercial goods or services.

### SUMMARY

By way of introduction, the embodiments described below are drawn to database or online search, and more particularly, to generating geographically-targeted search results from a database based on whether a user submitting the query is a local user or a traveler.

In a first aspect, a computer-implemented method is disclosed for serving user queries adaptively based on whether the query is submitted by a local user or a traveler, including: receiving by a search engine a query from a communication device, the query including one or more search terms; detecting a type of keyword term by a context detector of the search engine that indicates a geographic context of the query; determining whether a user of the communication device is the local user or the traveler based on the geographic context; and delivering geographically-targeted search results by the search engine to the communication device based on determining that the user is either the traveler or the local user.

In a second aspect, a computer-implemented method is disclosed for serving user queries adaptively based on whether the query is submitted by a local user or a traveler, including: receiving by a search engine a query from a communication device of a user, the query including one or more search terms; generating, by the search engine, a ranked set of search results based on a search of a database for pages relevant to the one or more terms; detecting, by the search engine, a geo-location or set of coordinates associated with one or more specific listings within the search results; determining, by the search engine, a location of the user; determining that the user is a local user or a traveler based on a distance calculated between the user location and the geo-location or set of coordinates of the one or more specific listings; adjusting, by the search engine, the ranked set of search results to make the search results geographically-targeted to, respectively, the local user or the traveler; and delivering the geographically-targeted search results by the search engine to the communication device of the user.

In a third aspect, a search engine is disclosed for serving user queries adaptively based on whether the query is submitted by a local user or a traveler, including a memory; a processor coupled with the memory; and a communication interface coupled with the processor and operable to receive a query from a communication device of a user, the query including one or more search terms. A context detector is coupled with the communication interface and is operable to detect a type of keyword term within the query that indicates a geographic context of the query. The processor determines whether the user of the communication device is the local user or the traveler based on the geographic context. The communication interface delivers geographically-targeted search results by the search engine to the communication device based on determining that the user is either the traveler or the local user.

In a fourth aspect, a search engine is disclosed for serving user queries adaptively based on whether the query is submitted by a local user or a traveler, including a memory and a database; a processor coupled with the memory and the database; and a communication interface coupled with the processor and operable to receive a query from a communication device of a user, the query including one or more search terms. A search results generator is coupled with the processor and the database and is operable to generate a ranked set of search results based on a search of the database for pages relevant to the one or more terms. A context detector is coupled with the processor and is operable to detect a geo-location or set of coordinates associated with one or more specific listings within the search results. A location detector is coupled with the processor and is operable to determine a location of the user. The processor is operable to determine that the user is a local user or a traveler based on a distance calculated between the user location and the geo-location or set of coordinates of the one or more specific listings. The search results generator is operable to adjust the ranked set of search results to make the search results geographically-targeted to, respectively, the local user or the traveler. The communication interface is operable to deliver the geographically-targeted search results by the search engine to the communication device of the user.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like-referenced numerals designate corresponding parts throughout the different views.

FIG. 1 is a diagram of an exemplary system for generating geographically-targeted search results from a database based on whether a user submitting the query is a local user or a traveler.

FIG. 2 is an exemplary mobile communications device capable of sending and receiving the search query and search results, respectively, as referred to in FIG. 1.

FIG. 3 is a flow chart of an exemplary method for adaptively serving geographically-targeted search results from a database based on whether a user submitting the query is a local user or a traveler.

FIG. 4 is a flow chart of another embodiment of a method for adaptively serving geographically-targeted search results from a database based on whether a user submitting the query is a local user or a traveler.

### DETAILED DESCRIPTION

By way of introduction, this disclosure is related to database or online search, and more particularly, to generating geographically-targeted search results from a database based on whether a user submitting the query is a local user or a traveler. As discussed above, searchers oftentimes receive unintended results from poorly-worded search queries or from a lack of context provided by a search engine to geography of the searchers. Given the historical and/or language context of search queries and their terms, search engines may help return search results that are more meaningful. Because of human nature, search queries in general may include trends that may be tracked, and therefore, predicted in future behavior. Such behavior may vary based on whether a searcher is a local or a traveler. Likewise, certain terms used in queries may indicate whether the searcher is a local or a traveler.

For instance, local users typically do not include geographic terms in search queries because they know where they are at, and location is an afterthought. In contrast, travelers are very conscious of location because they may be planning a trip to, or are located in, a different location than their local town or city. Accordingly, searching trends suggest that queries of travelers do generally include geographic terms. For instance, a search may be submitted that says “restaurants in San Francisco” or “Seattle attractions.” The terms of these search queries carry a context of a traveler. Also, searches regarding specific places, events, or people may indicate that a person is a local user or a traveler. For instance, a search may be submitted for “Fisherman's Warf” or “Pike Place Market,” which may be an indication that a traveler submitted the query because these are very popular tourist destinations in their respective cities.

Furthermore, listings with search results may include a geo-position or set of coordinates having been tagged with this location identifier during off-line analysis of the content of the Web page or document associated therewith. Determination of a distance between a location of a search result listing and a location of a user may indicate whether the user is a local user or a traveler. Likewise, a distance between a user-submitted default location and a current user location may be an indication of whether to treat the user as a local user or as a traveler.

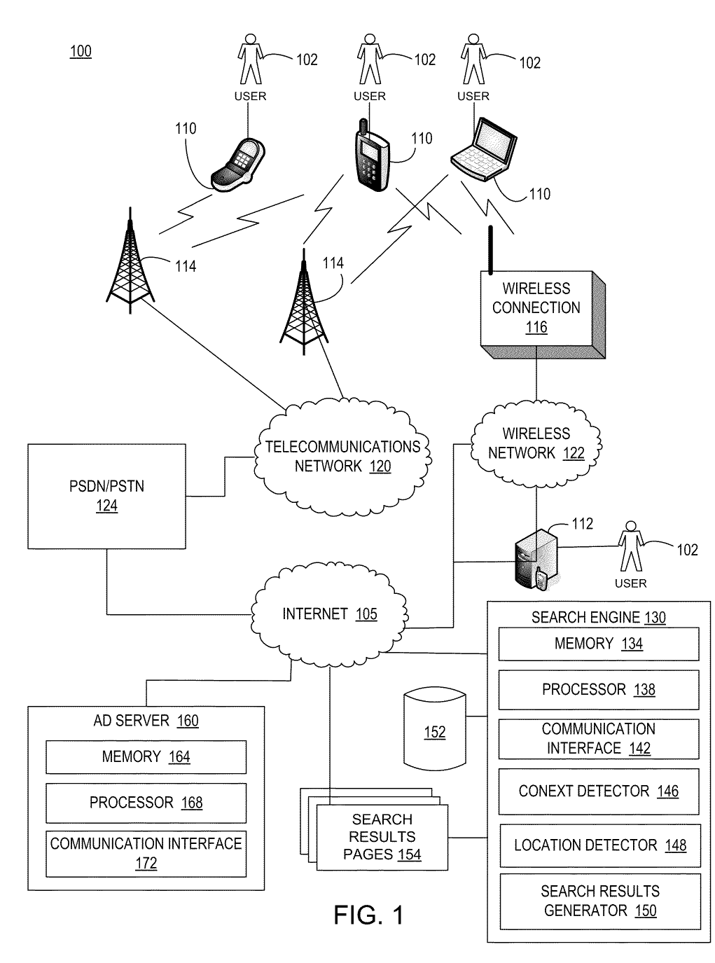

FIG. 1 is a diagram of an exemplary system 100 for generating geographically-targeted search results from a database based on whether a user 102 submitting the query is a local user or a traveler. The users 102 may communicate over, and search through, an Internet or World Wide Web (“Web”) 105 through any number of mobile communication devices 110 such cell phones, personal digital assistants (PDAs), a Blackberry™ by Research in Motion™, a laptop computer, a Bluetooth device, and any other mobile or semi-mobile device 1 10. The users 102 may also communicate over and search the Internet 105 through a personal computer 112 or other stationary communication device 112. The mobile devices 110 may wirelessly communicate with base transceiver stations 114, also referred to as cell sites or cellular towers. The system 100 may further include a wireless connection 116, such as a wireless hub, router, or the like.

The transceiver stations 114 may be coupled with a telecommunications network 120, which may include various pieces of switching hardware such as routers, switches, hubs, etc. Herein, the phrase “coupled with” is defined to mean directly connected to or indirectly connected through one or more intermediate components. The wireless connection 116 may be coupled with a wireless network 122, which may involve WiFi, Bluetooth, 802.11a, 802.11b, or the like technology for passing networked traffic, both voice and data. The stationary communications device 112 may also connect through the wireless network 122. The system 100 may further include a Public Switched Data (and/or Telephone) Network (PSDN/PSTN) 124 through which the telecommunications network 120 may connect to the Internet 105. The Internet 105 may encompass other networks such as an intranet, a local area network (LAN), a wide area network (WAN), etc. The PSDN/PSTN 124 may include or be coupled with an Internet gateway (not shown) to facilitate access to the Internet 105. The mobile communication devices 110 may transfer and receive digital information or electronic data through the telecommunication network 120, through the wireless network 122, and over the Internet 105.

The system 100 may further include a search engine 130, including a memory 134, a processor 138, a communication interface 142, a context detector 146, a location detector 148, a search results generator 150, a database 152, all of which may be coupled together and function to yield search results pages 154. The search results pages 154 may be sent over the Internet 105 and, where appropriate, over the telecommunications or wireless networks 120, 122 to any of the users 102 in response to a search query submitted by a user 102. The search results returned in response to any given query may be personalized to the user 102 based on whether the search engine 130 determines the user 102 is a local or a traveler. The search results pages 154, as formatted by the search results generator 150, accordingly, may include a single reference to a document or Web page, or may be populated from documents, Web pages, and other data relevant to terms of the search query. The system 100 may also include an ad server 160, including a memory 164, a processor 168, and a communication interface 172.

The context detector 146 may be configured to, together with the processor 138, detect certain terms or usage of terms within a search query. The context detector 146 may include a language detector of some sort that will detect whether a geographic term is used within a query. The context detector 146 may further be configured to match query terms with any query terms stored in the database 152 that indicate whether the searching user 102 is a local user or a traveler, e.g., “Fisherman's Warf” or “Pike Place Market.” Such terms may include geographical words, but also other words, for instance, nouns of popular tourist destinations and the like which may indicate that a searcher is a traveler. If it can be reliably determined, with high probability, that the user 102 is a traveler, the user 102 is not treated as a local user.

The location detector 148 may be configured to, together with the processor 138 and the communication interface 142, detect a location of a mobile or a stationary communication device 110, 112. Detecting locations of mobile or semi-mobile communication devices 110, however, may be more applicable as stationary communication devices 112 will rarely be carried on the road while traveling. The location detector 148 may further be configured to receive or determine a default location of the mobile or the stationary communications devices 110, 112. For instance, a global positioning system (GPS) device of a mobile communication device 110 may send a location to the search engine 130, or a network card (not shown) of the stationary communication device 112 may send a physical or internet protocol (I.P.) address that indicates location to the search engine 130. In some cases, the searching users 102 may submit their default (or local) locations; in other cases, the default locations may be determined by an originating phone number or through a participating service provider.

Once the search engine 130 has decided whether or not a searching user 102 is a local user or traveler, if determinable, the search engine 130 may then conduct a geographically-targeted search in lieu of a regular, non-geographically-targeted search. A mobile search aspect of the search engine 130 may incorporate a local-specific search engine such as local.yahoo.com so that a local-specific search may be performed if it is determined that the user 102 is a local user. A regular search or a search tailored to a traveler may be performed if it is determined that the user 102 is a traveler. If it cannot be determined whether or not the user 102 is a local user or a traveler, than the search engine 130 performs a regular search without regards to making a distinction. The search results that are returned by the search engine 130 are sent to the communications device 110, 112 of the searching user 102.

Note that a search query could be sent from the stationary communication device 112 and returned to the stationary communication device 112 or to a mobile communication device 110 depending on a setting submitted by the user 102. The context of the query terms of a search query, although submitted by the stationary communication device 112, may still result in a determination that the user 102 is a traveler, although not physically traveling because that user 102 may be planning a trip, for instance.

In yet another embodiment, the context detector 146 may detect a geo-location or set of coordinates associated with one or more specific listings of a set of ranked search results returned by the search results generator 150 in response to a user query. This association may have occurred offline by analyzing each page of the one or more specific listings for location information, and tagging the listings with a related position or location. With knowledge of the user location as discussed herein, the search engine 130 may determine that a user 102 is a local user or a traveler by calculating a distance between the geo-location or set of coordinates of the one or more specific search listings and the location of the user 102. If the calculated distance is within a pre-determined threshold distance, the user 102 is determined to be a local user and if the calculated distance is beyond the predetermined threshold distance, the user 102 is determined to be a traveler. The search results generator 130 may then adjust the ranked set of search results to make the search results geographically-targeted to, respectively, the local user or the traveler depending on the type of the user 102, as determined by the search engine 130. The communication interface 142 may then deliver the adjusted, or geographically-targeted, search results to the communication device 110, 112 of the user 102.

The adjustment to the make the search results geographically-targeted may include various changes. For instance, the search results may be re-ranked so that the specific listings having a geo-position or set of coordinates that are geographically-relevant to the local user or traveler are listed higher in the search results. Furthermore, the display of a description included with the one or more specific listings of the search results may be changed to highlight geographically-relevant information to the local user or to the traveler. For instance, if the user 102 is a local user, then the description may be adjusted to display information more relevant or interesting to a local. One non-exhaustive example includes a result for a parent teach association (PTA) page in which a local user may be a parent or teacher that wants to get the results of the last meeting and perhaps the time and place of the next PTA meeting. In contrast, if the user 102 is a traveler, then the description may be adjusted to display information more relevant to the traveler. In the instant example, this may be to highlight the history of this particular PTA and its make up as the traveler is less likely to be interested in specifics of its local meetings.

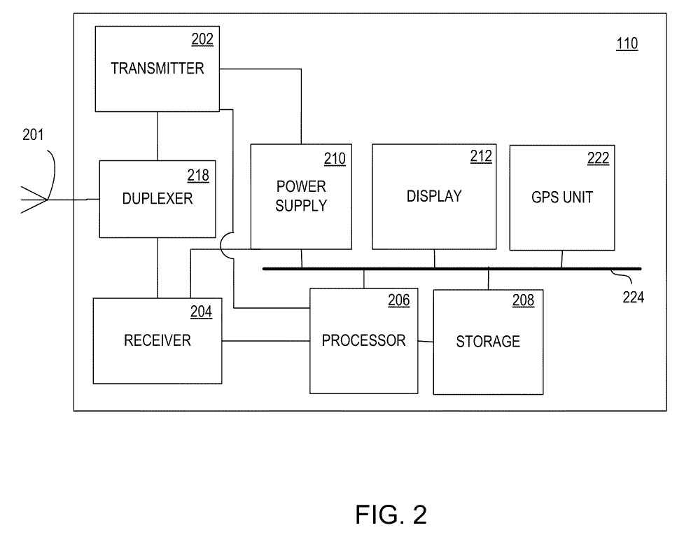

FIG. 2 is an exemplary mobile communications device 110 capable of sending and receiving the search query and search results, respectively, as referred to in FIG. 1. The mobile communication device 110 includes an antenna 201, a transmitter 202, a receiver 204, a processor 206, a storage 208 (or memory 208), a power supply 210, a display 212, a duplexer 218, a global positioning system (GPS) unit 222, and a communications bus 224. The storage 208 may include software to run the mobile communications device 110, which is configured to send a search query and receive search results from the search engine 130 over the Internet 105 or other network. As shown in this embodiment, the processor 206, the storage 208, the power supply 210, the display 212, and the GPS unit 222 are coupled to a communications bus 224. The communications bus 224 is operable to transmit control and communications signals from and between the components connected to the communications bus 224, such as power regulation, memory access instructions, GPS locations, and other system information. In alternative embodiments, the duplexer 218 directly couples the transmitter 202 and the receiver 204 to each other for faster two-way communications.

In the displayed embodiment, the processor 206 is coupled to the receiver 204 and to the transmitter 202. One of ordinary skill in the art will appreciate that the processor 206 may include the GPS unit 222. Also, the antenna 201, the transmitter 202, and receiver 204 may be configured to send and receive voice and/or data through the local wireless connection 116, to include a Wi-Fi connection, etc. The GPS unit 222 may send GPS coordinate locations to the location detector 146 of the search engine 130. The communication interface 142 receives and passes the GPS coordinate locations to the location detector 148, which communicates with the database 152 to compare a current location with a default location.

The display 212 may enable the user 102 of the mobile communication device 110 to enter a default location as a setting. The default location can be the home of the user 102, the place of work of the user 102, or another location close to the local area where the user 102 resides. Once the location detector 148 and/or processor 138 determine a distance between the current and default locations, the search engine 130 is able to determine if the user 102 is still a local user or has become a traveler. For instance, if the distance between the current and default locations are within a predetermined distance, the user 102 is determined to be a local user. If the user 102 is beyond the predetermined distance, the user 102 is determined to be a traveler. In the alternative, if the mobile communications device 110 indicates to the location detector 148 that the former is “roaming” outside of a normal communications area, the search engine 130 could automatically determine that the user 102 is a traveler. The current location may also be used to calculate a distance from a geo-location or set of coordinates of specific listings in search results as discussed with reference to FIG. 1.

The ad server 160 may be coupled with the search engine 130, either directly or over the Internet 105 or other network, to deliver advertisements relevant to the search query to the search results pages 154, which are to be delivered to individual users 102 together with the search results. The extent and size of such advertisements, or whether they are delivered at all, may be limited by the display size of the mobile communications devices 110 receiving the search results. The ad server 160 may communicate with the context detector 146 and/or the location detector 148 to receive information regarding the terms used in the query and any geographical context that may help the ad server 160 to geographically-target advertisements to be delivered with the search results. The decision whether to geographically-target advertisements may include a process similar to that disclosed with reference to deciding whether to geographically-target search results as disclosed herein. The ad server 160 and the search engine 130 may be coupled and even share resources; accordingly, the process may be the same process as executed by either or both of the ad server 160 and the search engine 130.

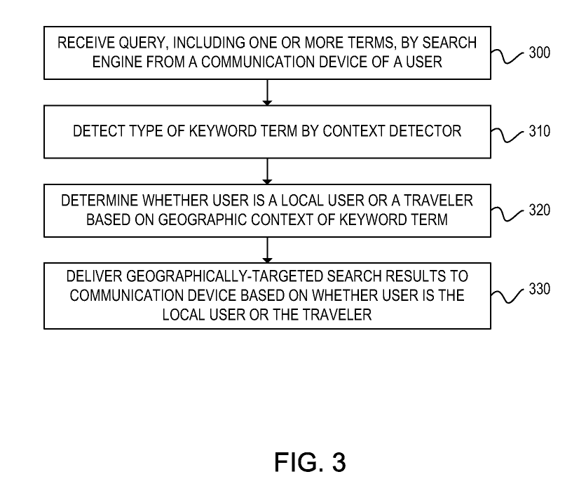

FIG. 3 is a flow chart of an exemplary method for adaptively serving geographically-targeted search results from the database 152 based on whether a user 102 submitting the query is a local user or a traveler. At block 300, the search engine 130 receives a query from a communication device 110, 112, the query including one or more search terms. At block 310, a context detector 146 of the search engine 130 detects a type of keyword term that indicates a geographic context of the query. At block 320, the search engine 130 determines whether the user 102 of the communication device 110, 112 is the local user or the traveler based on the geographic context. At block 330, the search engine 130 delivers geographically-targeted search results to the communication device 110, 112 based on determining that the user 102 is either the traveler or the local user.

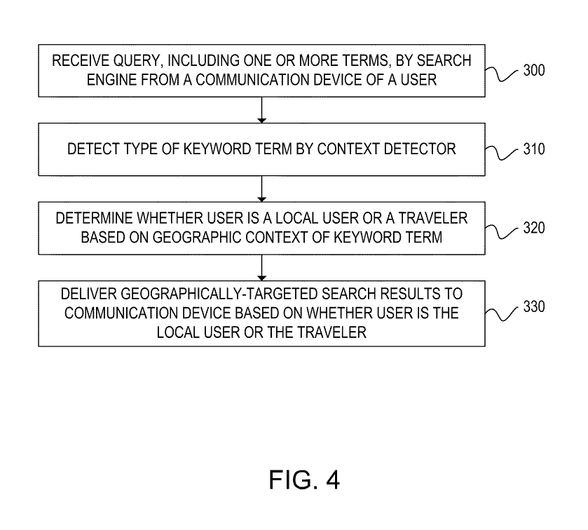

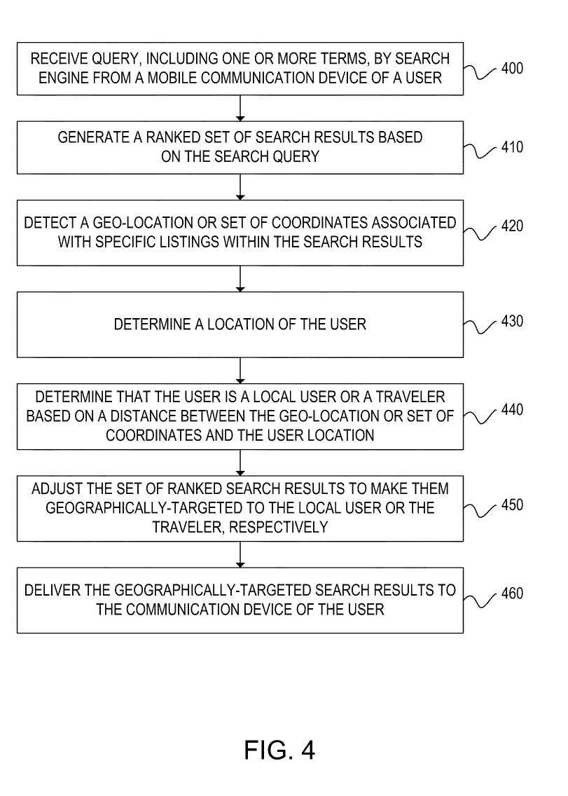

FIG. 4 is a flow chart of another embodiment of a method for adaptively serving geographically-targeted search results from the database 152 based on whether a user 102 submitting the query is a local user or a traveler. At block 400, a search engine 130 receives a query from a mobile communication device 110 of the user 102, the query including one or more search terms. At block 410, the search engine 130 generates a ranked set of search results based on a search of a database 152 for pages relevant to the one or more terms. At block 420, the processor 138 of the search engine 130 detects a geo-location or set of coordinates associated with one or more specific listings within the search results. At block 430, the search engine 130 determines a location of the user 102. At block 440, the search engine 130 determines that the user 102 is a local user or a traveler based on a distance calculated between the user location and the geo-location or set of coordinates of the one or more specific listings. At block 450, the search engine 130 adjusts the ranked set of search results to make the search results geographically-targeted to, respectively, the local user or the traveler. At block 460, the search engine 130 delivers the geographically-targeted search results to the communication device 110, 112 of the user 102.

In the foregoing description, numerous specific details of programming, software modules, user selections, network transactions, database queries, database structures, etc., are provided for a thorough understanding of various embodiments of the systems and methods disclosed herein. However, the disclosed system and methods can be practiced with other methods, components, materials, etc., or can be practiced without one or more of the specific details. In some cases, well-known structures, materials, or operations are not shown or described in detail. Furthermore, the described features, structures, or characteristics may be combined in any suitable manner in one or more embodiments. The components of the embodiments as generally described and illustrated in the Figures herein could be arranged and designed in a wide variety of different configurations.

The order of the steps or actions of the methods described in connection with the disclosed embodiments may be changed as would be apparent to those skilled in the art. Thus, any order appearing in the Figures, such as in flow charts, or in the Detailed Description is for illustrative purposes only and is not meant to imply a required order.

Several aspects of the embodiments described are illustrated as software modules or components. As used herein, a software module or component may include any type of computer instruction or computer executable code located within a memory device and/or transmitted as electronic signals over a system bus or wired or wireless network. A software module may, for instance, include one or more physical or logical blocks of computer instructions, which may be organized as a routine, program, object, component, data structure, etc. that performs one or more tasks or implements particular abstract data types.

In certain embodiments, a particular software module may include disparate instructions stored in different locations of a memory device, which together implement the described functionality of the module. Indeed, a module may include a single instruction or many instructions, and it may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices.

Various modifications, changes, and variations apparent to those of skill in the art may be made in the arrangement, operation, and details of the methods and systems disclosed. The embodiments may include various steps, which may be embodied in machine-executable instructions to be executed by a general-purpose or special-purpose computer (or other electronic device). Alternatively, the steps may be performed by hardware components that contain specific logic for performing the steps, or by any combination of hardware, software, and/or firmware. Embodiments may also be provided as a computer program product including a machine or computer-readable medium having stored thereon instructions that may be used to program a computer (or other electronic device) to perform processes described herein. The machine or computer-readable medium may include, but is not limited to, floppy diskettes, optical disks, CD-ROMs, DVD-ROMs, ROMs, RAMs, EPROMs, EEPROMs, magnetic or optical cards, propagation media or other type of media/machine-readable medium suitable for storing electronic instructions. For example, instructions for performing described processes may be transferred from a remote computer (e.g., a server) to a requesting computer (e.g., a client) by way of data signals embodied in a carrier wave or other propagation medium via a communication link (e.g., network connection).

1. A computer-implemented method for serving user queries adaptively based on whether the query is submitted by a local user or a traveler, the method comprising:
receiving by a search engine a query from a communication device, the query including one or more search terms;
detecting a type of keyword term by a context detector of the search engine that indicates a geographic context of the query;
determining whether a user of the communication device is the local user or the traveler based on the geographic context; and
delivering geographically-targeted search results by the search engine to the communication device based on determining that the user is either the traveler or the local user.

2. The method of claim 1, wherein the geographic context comprises the name of a city, state, or other geographic term, wherein it is determined that the user is the traveler.

3. The method of claim 1, wherein the query contains no geographic-related term, wherein it is determined that the user is the local user.

4. The method of claim 1, wherein the geographic context is implicitly determined from the one or more search terms of the query.

5. The method of claim 4, wherein the geographic context comprises a term associated with a tourist attraction, and it is determined that the user is the local user.

6. The method of claim 1, wherein the communication device comprises a mobile communication device, the method further comprising:
detecting a user-based setting including a default location; and
determining if the user is the local user or the traveler based on the default location and a current location of the mobile communication device.

7. The method of claim 6, wherein the default location and the current location are within a predetermined distance of each other, and it is determined that the user is the local user.

8. The method of claim 6, wherein the default location and the current location are further away than a predetermined distance from each other, and it is determined that the user is the traveler.

9. The method of claim 1, further comprising:
integrating a local-specific search by the search engine when it is determined that the user is the local user.

10. A computer-implemented method for serving user queries adaptively based on whether the query is submitted by a local user or a traveler, the method comprising:
receiving by a search engine a query from a communication device of a user, the query including one or more search terms;
generating, by the search engine, a ranked set of search results based on a search of a database for pages relevant to the one or more terms;
detecting, by the search engine, a geo-location or set of coordinates associated with one or more specific listings within the search results;
determining, by the search engine, a location of the user;
determining that the user is a local user or a traveler based on a distance calculated between the user location and the geo-location or set of coordinates of the one or more specific listings;
adjusting, by the search engine, the ranked set of search results to make the search results geographically-targeted to, respectively, the local user or the traveler; and
delivering the geographically-targeted search results by the search engine to the communication device of the user.

11. The method of claim 10, wherein adjusting comprises re-ranking the one or more specific listings of the search results with more geographically-targeted results listed first.

12. The method of claim 10, wherein the user is determined to be a local user if the distance is within a predetermined threshold distance and is determined to a be a traveler if the distance is greater than the predetermined threshold distance.

13. The method of claim 12, wherein adjusting comprises reformatting a displayed description associated with the one or more specific listings to include local-specific information if the user is determined to be a local user.

14. The method of claim 12, wherein adjusting comprises reformatting a displayed description associated with the one or more specific listings to include traveler-specific information if the user is determined to be a traveler.

15. The method of claim 10, wherein determining the location of the user comprises receiving a set of global position system (GPS) coordinates from a mobile communication device of the user or receiving a physical network address from a stationary communication device.

16. A search engine for serving user queries adaptively based on whether the query is submitted by a local user or a traveler, the system comprising:
a memory;
a processor coupled with the memory;
a communication interface coupled with the processor and operable to receive a query from a communication device of a user, the query including one or more search terms;
a context detector coupled with the communication interface and operable to detect a type of keyword term within the query that indicates a geographic context of the query;
wherein the processor determines whether the user of the communication device is the local user or the traveler based on the geographic context; and
wherein the communication interface delivers geographically-targeted search results by the search engine to the communication device based on determining that the user is either the traveler or the local user.

17. The search engine of claim 16, further comprising:
a database, wherein the context detector compares the keyword terms of the query with query terms saved in the database that are associated with a geographic context, wherein the saved query terms include tourist attractions.

18. The search engine of claim 16, wherein the geographic context comprises the name of a city, state, or other geographic term, wherein the processor determines that the user is the traveler.

19. The search engine of claim 16, wherein the query contains no geographic-related term, and the context detector implicitly determines, from content of the one or more search terms, that the user is the local user or the traveler.

20. The search engine of claim 16, wherein the communication device comprises a personal computer and wherein the geographically-targeted search results are delivered to a mobile communication device of the user.

21. The search engine of claim 16, wherein the communication device comprises a mobile communication device, further comprising:
a location detector to detect or receive a user setting including a default location, wherein the processor determines if the user is the local user or the traveler based on the default location and a current location of the mobile communication device.

22. The search engine of claim 21, wherein the default location and the current location are within a predetermined distance of each other, and the processor determines that the user is the local user.

23. The search engine of claim 21, wherein the default location and the current location are further away than a predetermined distance from each other, and the processor determines that the user is the traveler.

24. The search engine of claim 16, wherein the processor integrates a local-specific search in a search engine search when it determines that the user is the local user.

25. The search engine of claim 16, further comprising:
an ad server coupled with the search engine and operable to deliver one or more advertisements to be sent with the search results to the communication device, wherein the one or more advertisements are related to the geographic context of the search query if it is determined that the user is either the local user or the traveler.

26. A search engine for serving user queries adaptively based on whether the query is submitted by a local user or a traveler, the system comprising:
a memory and a database;
a processor coupled with the memory and the database;
a communication interface coupled with the processor and operable to receive a query from a communication device of a user, the query including one or more search terms;
a search results generator coupled with the processor and the database and operable to generate a ranked set of search results based on a search of the database for pages relevant to the one or more search terms;
a context detector coupled with the processor and operable to detect a geo-location or set of coordinates associated with one or more specific listings within the search results;
a location detector coupled with the processor and operable to determine a location of the user;
wherein the processor is operable to determine that the user is a local user or a traveler based on a distance calculated between the user location and the geo-location or set of coordinates of the one or more specific listings;
wherein the search results generator is operable to adjust the ranked set of search results to make the search results geographically-targeted to, respectively, the local user or the traveler; and
wherein the communication interface is operable to deliver the geographically-targeted search results by the search engine to the communication device of the user.

27. The search engine of claim 26, wherein the search results generator adjusts the ranked set of search results through re-ranking the one or more specific listings of the search results with more geographically-targeted results listed first.

28. The search engine of claim 26, wherein the context detector determines that the user is a local user if the distance is within a predetermined threshold distance and that the user is a traveler if the distance is greater than the predetermined threshold distance.

29. The search engine of claim 28, wherein the search results generator adjusts the ranked set of search results through reformatting a displayed description associated with the one or more specific listings to include local-specific information if the user is determined to be a local user.

30. The search engine of claim 28, wherein the search results generator adjusts the ranked set of search results through reformatting a displayed description associated with the one or more specific listings to include traveler-specific information if the user is determined to be a traveler.
